(19) United States
(12) Patent Application Publication
(10) Pub. No.: US 2024/0070261 A1
(43) Pub. Date: Feb. 29, 2024

(54) MALWARE IDENTIFICATION AND PROFILING

(71) Applicant: SAUDI ARABIAN OIL COMPANY, Dhahran (SA)

(72) Inventors: Faisal Abdullah BIN HURAIB, Al Khobar (SA); Majed Ali HAKAMI, Dhahran (SA); Rakan Hussain YAMANI, Dammam (SA)

(73) Assignee: SAUDI ARABIAN OIL COMPANY, Dhahran (SA)

(21) Appl. No.: 17/822,928

(22) Filed: Aug. 29, 2022

(51) Int. Cl. G06F 21/53; G06F 21/56

(52) U.S. Cl. CPC G06F 21/53; G06F 21/563; G06F 21/564

(57) ABSTRACT

The present disclosure generally relates to a multi-phase malware identification and/or profiling process that can be implemented by one or more computer systems and/or computer-implemented methods. For example, one or more embodiments described herein can regard a method that includes detecting one or more cybersecurity threat indicators of malware targeting a computer device. The one or more cybersecurity threat indicators can characterize a delivery of the malware, an infrastructure of the malware, or a combination thereof. The method can also include generating an adversary profile that includes a correlation between the one or more cybersecurity threat indicators and an operation of the malware.

### FIELD OF THE DISCLOSURE

The present disclosure relates generally to the identification and/or profiling of one or more malware campaigns and, more particularly, to systems and/or computer-implemented methods for autonomous multi-phase malware identification and/or profiling processes that can analyze one or more cybersecurity threats to computing devices and/or networks.

### BACKGROUND OF THE DISCLOSURE

Cybersecurity threats are malicious acts performed by a bad actor seeking to damage, steal, disrupt, and/or manipulate data of a targeted computer and/or network. Malware is a type of software typically employed to execute cybersecurity attacks. Conventionally, malware has been utilized to cause disruption in computer systems, gain unauthorized access to information, deprive user access to information, and/or otherwise interfere with a computer's security and privacy. Example types of malware include, but are not limited to: computer viruses, computer worms, Trojan horse software, ransomware, spyware, adware, rogue software, wiper software, scareware, and/or the like.

With each passing year, malware is becoming increasingly advanced and sophisticated. For example, malware campaigns can be designed to learn about a targeted computer system's infrastructure and develop software tailored to identified security weaknesses. Thereby, malware can enable bad actors to gain unauthorized access into computer systems, conduct harmful operations, and/or extract critical data.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method is provided. The method can include detecting one or more cybersecurity threat indicators of malware targeting a computer device. The one or more cybersecurity threat indicators can characterize a delivery of the malware, an infrastructure of the malware, or a combination thereof. Also, the method can include generating an adversary profile that includes a correlation between the one or more cybersecurity threat indicators and an operation of the malware.

In another embodiment, a system is provided. The system can include a memory to store computer executable instructions. The system can also include one or more processors, operatively coupled to the memory, that execute the computer executable instructions to implement a malware analyzer configured to detect one or more cybersecurity threat indicators of malware targeting a computer device. The one or more cybersecurity threat indicators can characterize a delivery of the malware, an infrastructure of the malware, or a combination thereof. Also, the one or more processors can execute the computer executable instructions to implement a profile engine configured to generate an adversary profile that includes a correlation between the one or more cybersecurity threat indicators and an operation of the malware.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 illustrates a block diagram of a non-limiting example system that implement one or more malware identification and/or profiling processes to generate an adversary profile of malware targeting one or more protected computer devices in accordance with one or more embodiments described herein.

FIG. 2 illustrates a diagram of a non-limiting example communication scheme between system components that can be implemented to facilitate one or more malware identification and/or profiling processes in accordance with one or more embodiments described herein.

FIG. 3 illustrates a flow diagram of a non-limiting example method that can be implemented by one or more systems to perform one or more malware identification and/or profiling processes in accordance with one or more embodiments described herein.

FIG. 4 illustrates a block diagram of non-limiting example computer environment that can be implemented within one or more systems described herein.

### DETAILED DESCRIPTION

Embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Conventionally, the detection and/or assessment of malware is performed by a team of subject matter experts familiar with the targeted computer system and/or the types of malware currently being employed by bad actors. When a malware attack is detected, the subject matter experts perform a manual analysis of the malware's origins and/or operations. This analysis can be costly and time consuming at a moment when speed and efficiency can significantly impact the likelihood of successfully thwarting the present cybersecurity threat or a future cybersecurity threat.

Embodiments in accordance with the present disclosure generally relate to systems and/or computer-implemented methods that can identify and/or profile one or more malware campaigns targeting one or more protected computer devices. In various embodiments, the malware identification and/or profiling described herein can include a multi-phase process to provide a holistic analysis of the malware itself, the malware's operations, technological advances and/or deviations exhibited by the malware, and/or the malware's interactions with the targeted computer devices and systems.

For example, a first phase of the malware identification and/or profiling process can include a delivery vector analysis that can identify information regarding the origin and/or delivery of the detected malware. A second phase of the malware identification and/or profiling process can include a dynamic malware analysis that detect and/or track the malware's behavior as it runs in the host computer environment (e.g., track how the malware interacts with the systems of the protected computer devices). A third phase of the malware identification and/or profiling process can include a static malware analysis that inspects the malware to identify hidden content, such as: metadata, embedded strings, and/or extracted keywords. A fourth phase of the malware identification and/or profiling process can include a malware code analysis that can reverse engineer at least a portion of the malware's source code. A fifth phase of the malware identification and/or profiling process can include a malware code comparison analysis that can identify one or more variations in the malware's source code, as compared to known versions of the malware. A sixth phase of the malware identification and/or profiling process can include a profile analysis that can generate one or more reports summarizing the determinations of the previous phases. The numbering of the phases is not necessarily indicative of the order in which they are performed.

In various embodiments described herein, one or more phases of the malware identification and/or profiling process can utilize one or more intelligence feeds to leverage knowledge gained and shared by the cybersecurity community. For example, the one or more intelligence feeds can include one or more analyses performed by one or more third party security entities regarding cybersecurity threats and/or specific instances of malware. Additionally, one or more embodiments described herein can generate and/or maintain a central database regarding malware indicators and/or parameters extracted during one or more phases of the malware identification and/or profiling process. Further, one or more embodiments described herein can employ a correlation engine to identify commonalities and/or trends between identified malwares.

Moreover, various embodiments described herein can constitute one or more technical improvements over conventional malware analysis techniques by developing a comprehensive adversary profile that can delineate the threat trajectory of a malware campaign. For instance, various embodiments described herein can detect cybersecurity threat indicators that characterize the delivery, infrastructure, and/or operation of malware targeting one or more protected computer devices. Further, various embodiments described herein can enable malware detection and profiling processes that are independent of a user's expertise in cybersecurity analysis. Additionally, one or more embodiments described herein can markedly improve the speed and/or efficiency of a malware campaign analysis, as compared to traditional methodologies, which can be particularly relevant in addressing cybersecurity threats that are capable of adapting in real time to different computer environments. In addition, the autonomous nature of the various embodiments described herein can comply with strict data privacy regulations, which may inhibit the amount of permissible monitoring performed by a human.

In addition, one or more embodiments described herein can have a practical application by utilizing a correlation engine to identify one or more correlations between the cybersecurity threat indicators and the operation of the malware. For example, one or more embodiments described herein can control: dynamic analysis tools to monitor operation of the malware in a sandbox environment; and static analysis tools to analyze the source code of the malware for cybersecurity threat indicators and/or commonalities with historic malware specimens. In another example, one or more embodiments described herein can generate one or more databases of indicators and/or advisory profiles that are readily searchable; thereby facilitating the detection and/or analysis of future malware attacks that may share one or more commonalities. In a further example, various embodiments described herein can be employed to provide a comprehensive and/or robust cybersecurity protocol for complex computer systems without sacrificing efficiency. For instance, as the size and/or complexity of a protect computer system increases, the difficulty in manually monitoring the system in a comprehensive and efficient manner also increases.

As used herein, the term “indicator,” and/or grammatical variants thereof, refers to cybersecurity threat indicators derived from the delivery of malware, from the software infrastructure of malware, and/or from the operation of malware on a host computer environment. For example, indicators can include information utilized to describe and/or identify: malicious reconnaissance, including anomalous patterns of communication that appear to be transmitted for the purpose of gathering technical information related to a cybersecurity treat or security vulnerability; a method of defeating a security control or exploitation of a security vulnerability; a security vulnerability, including anomalous activity indicative of the existence of security vulnerability; a method of causing a user with legitimate access to an information system or information that is stored on, processed by, or transiting an information system to unwittingly enable the defeat of a security control (e.g., including the exploitation of a security vulnerability); malicious cyber command and control; the actual or potential harm caused by an incident, including a description of information exfiltrated as a result of a particular cybersecurity threat; and/or a combination thereof.

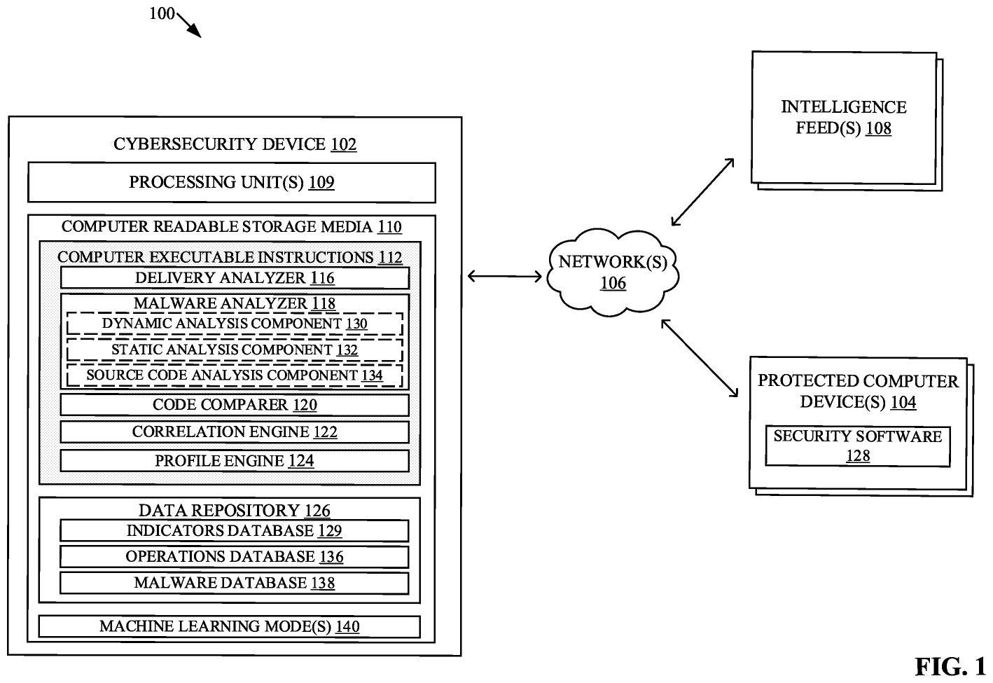

FIG. 1 illustrates a non-limiting example system 100 that can comprise the one or more cybersecurity devices 102, protected computer devices 104, networks 106, and/or intelligence feeds 108 in accordance with one or more embodiments described herein. In various embodiments, the one or more cybersecurity devices 102 (e.g., a server, a desktop computer, a laptop, a hand-held computer, a programmable apparatus, a minicomputer, a mainframe computer, an Internet of things (“IoT”) device, and/or the like) can be operably coupled to (e.g., communicate with) the one or more protected computer devices 104 and/or intelligence feeds 108 via the one or more networks 106.

As shown in FIG. 1, the one or more cybersecurity devices 102 can comprise one or more processing units 109 and/or computer readable storage media 110. In various embodiments, the computer readable storage media 110 can store one or more computer executable instructions 112 that can be executed by the one or more processing units 109 to perform one or more defined functions. In various embodiments, a delivery analyzer 116, malware analyzer 118, code comparer 120, correlation engine 122, and/or profile engine 124 can be computer executable instructions 112 and/or can be hardware components operably coupled to the one or more processing units 109. For instance, in some embodiments, the one or more processing units 109 can execute the delivery analyzer 116, malware analyzer 118, code comparer 120, correlation engine 122, and/or profile engine 124 to perform various functions described herein (e.g., a multi-phase malware identification and/or profiling process). Additionally, the computer readable storage media 110 can store a data repository 126, which can include information regarding current and/or previous malware detections.

The one or more processing units 109 can comprise any commercially available processor. For example, the one or more processing units 109 can be a general purpose processor, an application-specific system processor (“ASSIP”), an application-specific instruction set processor (“ASIPs”), or a multiprocessor. For instance, the one or more processing units 109 can comprise a microcontroller, microprocessor, a central processing unit, and/or an embedded processor. In one or more embodiments, the one or more processing units 109 can include electronic circuitry, such as: programmable logic circuitry, field-programmable gate arrays (“FPGA”), programmable logic arrays (“PLA”), an integrated circuit (“IC”), and/or the like.

The one or more computer readable storage media 110 can include, but are not limited to: an electronic storage device, a magnetic storage device, an optical storage device, an electromagnetic storage device, a semiconductor storage device, a combination thereof, and/or the like. For example, the one or more computer readable storage media 110 can comprise: a portable computer diskette, a hard disk, a random access memory (“RAM”) unit, a read-only memory (“ROM”) unit, an erasable programmable read-only memory (“EPROM”) unit, a CD-ROM, a DVD, Blu-ray disc, a memory stick, a combination thereof, and/or the like. The computer readable storage media 110 can employ transitory or non-transitory signals. In one or more embodiments, the computer readable storage media 110 can be tangible and/or non-transitory. In various embodiments, the one or more computer readable storage media 110 can store the one or more computer executable instructions 112 and/or one or more other software applications, such as: a basic input/output system (“BIOS”), an operating system, program modules, executable packages of software, and/or the like.

The one or more computer executable instructions 112 can be program instructions for carrying out one or more operations described herein. For example, the one or more computer executable instructions 112 can be, but are not limited to: assembler instructions, instruction-set architecture (“ISA”) instructions, machine instructions, machine dependent instructions, microcode, firmware instructions, state-setting data, configuration data, source code, object code, a combination thereof, and/or the like. For instance, the one or more computer executable instructions 112 can be written in one or more procedural programming languages. Although FIG. 1 depicts the computer executable instructions 112 stored on computer readable storage media 110, the architecture of the system 100 is not so limited. For example, the one or more computer executable instructions 112 can be embedded in the one or more processing units 109.

The one or more networks 106 can comprise one or more wired and/or wireless networks, including, but not limited to: a cellular network, a wide area network (“WAN”), a local area network (“LAN”), a combination thereof, and/or the like. One or more wireless technologies that can be comprised within the one or more networks 106 can include, but are not limited to: wireless fidelity (“Wi-Fi”), a WiMAX network, a wireless LAN (“WLAN”) network, BLUETOOTH® technology, a combination thereof, and/or the like. For instance, the one or more networks 106 can include the Internet and/or the IoT. In various embodiments, the one or more networks 106 can comprise one or more transmission lines (e.g., copper, optical, or wireless transmission lines), routers, gateway computers, and/or servers. Further, the one or more cybersecurity devices 102 and/or protected computer devices 104 can comprise one or more network adapters and/or interfaces (not shown) to facilitate communications via the one or more networks 106.

In various embodiments, the one or more protected computer devices 104 can be one or more computer devices, servers, systems, networks, and/or entities monitored and/or protected by the one or more cybersecurity devices 102. For example, the one or more protected computer devices 104 can include security software 128 for detecting, inhibiting, and/or otherwise mitigating cybersecurity threats. For instance, the security software 128 can include antivirus software, antimalware software, firewall software, network security monitoring tools, encryption tools, web vulnerability scanning tools, network defense wireless tools, packet sniffer software, public key infrastructure (“PKI”) services, endpoint protection platforms (EPP), software security sandbox, security mail gateway, a combination thereof, and/or the like. Where a cybersecurity threat is detected on the one or more protected computer devices 104 and/or networks 106, for example by the security software 128, the security software 128 can alert the one or more cybersecurity devices 102 to further identify and/or profile the malicious activity. In various embodiments, the one or more protected computer devices 104 can share data with the one or more cybersecurity devices 102 that characterizes the delivery and/or operation of detected malware. Example data that can be supplied by the one or more protected computer devices 104 can include, but are not limited to: email correspondence, event logs, malware source code, security scan reports, quarantined software, operation status checks, a combination thereof, and/or the like. For instance, the one or more protected computer devices 104 can send, receive, and/or otherwise share data with the one or more cybersecurity devices 102 via a direct wired or wireless connection and/or the one or more networks 106.

In one or more embodiments, the cybersecurity device 102 can analyze data supplied by the one or more protected computer devices 104 to: identify malware that may be associated with the malicious activity; and/or generate an adversary profile of the malware, which can assist the security software 128 in thwarting the malware campaign. For example, the cybersecurity device 102 can execute a multi-phase malware identification and/or profiling process that can provide an in-depth and holistic analysis of the malware and its occurrence on the one or more protected computer devices 104.

In various embodiments, the delivery analyzer 116 can detect one or more indicators that are indicative of a malware's presence in the system 100 and/or an attempted delivery of the malware to the system 100. For example, the delivery analyzer 116 can monitor the one or more protected computer devices 104 and/or the network 106 for indicators such as: indicators of compromise (“IoCs”), indicators of attack (“IoAs”), and/or web indicators of compromise (“WIoCs”). The indicators can be stored in indicators database 129 of data repository 126. In one or more embodiments, the indicators can characterize how the malware was delivered, or attempted to be delivered, to the system 100 (e.g. to the one or more protected computer devices 104). For instance, where the malware is delivered via email, the delivery analyzer 116 can perform an email header analysis and/or an email content analysis. During the email header analysis, the delivery analyzer 116 can extract indicators delineating malware delivery details, such as metadata and/or origin information from the email used to deliver the malware. For instance, the delivery analyzer 116 can extract data from the return-path field, domainkeys identified mail (“DKIM”) signature field, message ID field, MIME-version field, recipient field, date/time field, and/or spam status field of the email header. In one or more embodiments, the delivery analyzer 116 can utilize one or more email header analysis tools (e.g., MX toolbox, e-mail header analyzer to determine if the given email header is compliant with one or more security standards (e.g., to determine if the given email is domain-based message authentication, reporting and conformance (“DMARC”) compliant). During the email content analysis, the delivery analyzer 116 can also evaluate the body of the email to detect keywords and/or phrases utilized to trick and/or confuse the recipient. For example, a malware delivery email can include a message designed to motivate the recipient to click a link, open an attachment, and/or perform another operation that ultimately facilitates infiltration of the malware onto the protected computer devices 104. The delivery analyzer 116 can identify language and/or phrases utilized to construct said motivation. For instance, the delivery analyzer 116 can execute one or more natural language processing algorithms to extract feature vectors from the body of the email, such as character strings for one or more keywords and/or patterns indicative of persuasive language. In one or more embodiments, the delivery analyzer 116 can utilize NLP algorithms and/or email header analysis techniques to identify malicious email, such as phishing and/or spam emails. Additionally, the delivery analyzer 116 can analyze emails for embedded hyperlinks, which may direct a user to a malicious domain and/or to download malicious content.

In some embodiments, the delivery analyzer 116 can further detect one or more IoCs and/or IoAs based on operations of the one or more protected computer devices 104 and/or networks 106. For example, one or more IoCs and/or IoAs can include digital evidence indicative of a malware infiltration of the one or more protected computer devices 104 and/or networks 106. For instance, malware may leave evidence (e.g., software artifacts) of its existence on the one or more protected computer devices 104 and/or networks 106, which can be detected and/or aggregated by the delivery analyzer 116 to determine the existence of malware in the system 100. In one or more embodiments, the delivery analyzer 116 can utilize one or more IoC security event and event management (“SIEM”) systems, threat intelligence platforms (“TIPs”), and/or security orchestration tools to detect and/or organize IoCs and/or IoAs in the system 100. Example types of IoC can include, but are not limited to: unusual outbound data traffic (e.g., large volumes of outbound data transfers and/or data traffic occurring outside of defined operation hours); irregular activity from high-privilege user accounts regarding sensitive data; activity outside of predefined geographic regions; high authentication failures; an increase in database reads that exceeds a defined threshold; an increase in requests to privileged files that exceeds a defined threshold; suspicious file configuration changes; a flood of data traffic to a specific site or location, a combination thereof, and/or the like.

In one or more embodiments, the malware analyzer 118 can extract one or more unique identifiers from the detected malware to reveal malware properties and/or characterize the operational behavior of the malware. As shown in FIG. 1, the malware analyzer 118 can include a dynamic analysis component 130, static analysis component 132, and/or source code analysis component 134.

In one or more embodiments, the dynamic analysis component 130 can interact with the malware to identify operational behavior of the malware as it is executed. For example, the dynamic analysis component 130 can execute detected malware in a safe computing environment, called a sandbox environment. As used herein, the term “sandbox environment” can refer to an isolated testing environment that can enable programs (e.g., malware) and/or files to be inspected, opened, and/or executed without affecting the computing system hosting the sandbox environment. For example, a malware executed in a sandbox environment can be isolated from the operations of the one or more protected computer devices 104 and/or networks 106. In various embodiments described herein, the dynamic analysis component 130 can utilize a sandbox environment on a dedicated device (e.g., one or more of the protected computer devices 104 and/or the cybersecurity device 102) and/or in a cloud computing system.

The sandbox environment can be isolated from the one or more protected computer devices 104 and/or other components of the system 100 so as not to jeopardize security and/or privacy of the one or more protected computer devices 104 while analyzing execution of the malware. By executing the malware in the sandbox environment, the dynamic analysis component 130 can identify one or more additional IoCs, which can then be stored in the indicators database 129. Examples of such IoCs can include, but are not limited to: IP addresses, domain names, files attributed to the malware, file path locations, a combination thereof, and/or the like. In one or more embodiments, the IoCs can be indicative of a communication protocol with an external server controlled by the bad actor that designed the malware. Additionally, the dynamic analysis component 130 can inform the delivery analyzer 116 of newly identified IoCs so that the delivery analyzer 116 can monitor the system 100 for one or more instances of the newly identified IoCs.

For instance, the dynamic analysis component 130 can analyze the malware's registry, file system, process and/or network activities. In another instance, the dynamic analysis component 130 can execute one or more memory forensics algorithms to analyze how the malware uses computer memory. In various embodiments, the dynamic analysis component 130 can perform one or more supervised operations. Additionally, in one or more embodiments, the dynamic analysis component 130 can execute the malware in a sandbox environment that simulates one or more operating conditions of the one or more protected computer devices 104 and/or networks 106. Example analysis tools that can be utilized by the dynamic analysis component 130 include, but are not limited to: Procmon, Process Explorer, Regshot, ApateDNS, Wireshark, and/or the like. In various embodiments, the dynamic analysis component 130 can store operational data in one or more operations databases 136. For instance, the operational data can include data collected during execution of the malware in the sandbox environment. The operational data can characterize how the malware operated during execution. For example, the operational data can: delineate data, files, and/or systems targeted by the malware; identify computer operations disrupted by the malware; define communication protocols established by the malware; define security vulnerabilities targeted by the malware; define system modifications performed by the malware, define data exfiltration, a combination thereof and/or the like.

In one or more embodiments, the static analysis component 132 can inspect the detected malware to identify additional hidden indicators, including, but not limited to: malware metadata, embedded strings, extracted keywords, header details, hashes, embedded resources, a combination thereof, and/or the like. For example, the static analysis component 132 can analyze the detected malware without running the malware (e.g., without running the malware in a sandbox environment). For instance, the static analysis component 132 can utilize one or more disassembler and/or network analyzer tools to analyze the malware code. In a further instance, the static analysis component 132 can execute one or more hashing and/or fuzzy hashing algorithms to analyze the malware. In various embodiments, the static analysis component 132 can employ any analysis technique that does not require execution of the malware itself, including, but not limited to: file metadata analysis, signature header analysis, hash analysis, malware string analysis, a combination thereof, and/or the like.

In one or more embodiments, the source code analysis component 134 can analyze the source code of the malware to identify signature indicators characterizing one or more digital signatures, which are indicative of unique program patterns that can correlate to one or more known bad actors and/or previous malware campaigns. For example, malware can comprise software objects, where the attributes and/or sequence of the objects can form a digital signature unique to the design of the malware. For instance, the digital signature can be a unique pattern of code from the malware. The source code analysis component 134 can identify one or more digital signatures from the malware code and store the digital signatures as one or more signature indicators in the one or more indicator databases 129. In various embodiments, the source code analysis component 134 can identify signature indicators as code elements of the malware that reference developing and/or creation tools and/or suites.

In some embodiments, the code comparer 120 can compare one or more patterns in the malware source code to one or more known digital signatures. Where the code comparer 120 identifies the one or more patterns as a known digital signature in the malware source code, one or more attributes of the detected malware can be correlated to historic malware associated with the known digital signature. For instance, the detected malware can be an alternate version of historic malware previously analyzed by the system 100, where both versions of the malware can share one or more digital signatures. Additionally, the code comparer 120 can compare one or more patterns in the malware source code to one or more digital signature (e.g., code elements) associated with a known bad actor. By correlating the malware source code to other known instances of malware and/or known bad actors, the cybersecurity device 102 can generate a robust characterization of the malware campaign in an adversary profile (e.g., generated by the profile engine 124).

In one or more embodiments, the code comparer 120 can compare the malware source code to previous versions of the malware to identify evolution indicators that are indicative of code variations exhibited by the malware, as compared to previous instances of the malware. In one or more embodiments, the code comparer 120 can analyze the malware source code while the malware is executed by the dynamic analysis component 130 in a sandbox environment. For example, the code comparer 120 can compare one or more snippets of the malware source code to historic snippets of previously detected and/or analyzed malware.

In various embodiments, the code comparer 120 can store one or more snippets of each malware specimen analyzed by the system 100 in one or more malware databases 138; thereby, the code comparer 120 can compare a current piece of malware to an archive of malware specimens to identify similarities and/or differences. As shown in FIG. 1, the one or more malware databases 138 can be located in the computer readable storage media 110 of the one or more cybersecurity devices 102. Alternatively, the one or more malware databases 138 can be distributed elsewhere in the system 100 (e.g., in one or more cloud computing environments) and accessible via the one or more networks 106. Additionally, the code comparer 120 can associate one or more indicators from the indicators database 129 with one or more of the archived malware specimens. For example, the code comparer 120 can choose an archived malware specimen to compare with the detected malware based on one or more shared indicators. For instance, where detected malware shares one or more signature indicators with a given archived malware specimen, the code comparer 120 can compare one or more snippets of code from the detected malware to code of the given archived malware. As such, the code comparer 120 can compare the detected malware to one or more previous versions of the malware. Further, the code comparer 120 can identify evolution indicators as one or more variations found during the comparison.

In various embodiments, the one or more intelligence feeds 108 can be trusted sources of cybersecurity analysis information. For example, the one or more intelligence feeds 108 can supply cybersecurity risk data that can be utilized by the one or more cybersecurity devices 102 to inform and/or validate detection of the one or more indicators described herein. For instance, the one or more intelligence feeds 108 can supply strategic, tactical, and/or operational cybersecurity threat information collected by one or more artificial intelligence programs from various sources, such as: open-source data, aggregated security data, internet crawling operations, cybersecurity organizations, a combination thereof, and/or the like. Example intelligence feeds 108 can include, but are not limited to: automated indicator sharing, infragard, internet storm center, and/or safe browsing. In one or more embodiments, the cybersecurity device 102 (e.g., and associated components thereof) can utilize the one or more intelligence feeds 108 to validate and/or authenticate one or more indicators.

As shown in FIG. 1, the one or more data repositories 126 can include the one or more indicators databases 129, operations databases 136, and/or malware databases 138. In one or more embodiments, the indicators database 129 can include various indicators (e.g., IoCs, IoAs, WIoCs, hidden IoCs, signature indicators, and/or evolution indicators) detected, extracted, and/or identified by the one or more computer executable instructions 112 (e.g., the delivery analyzer 116, the malware analyzer 118, and/or the code comparer 120). Further, the operations database 136 can include operational data characterizing malware activity and/or operations during execution in the sandbox environment (e.g., operational data collected by the dynamic analysis component 130). Additionally, the malware database 138 can include historic malware specimens previously analyzed by the system 100 and/or known by the one or more intelligence feeds 108. In various embodiments, the data repository 126 can organize indicators and/or operational data in association with the given malware being analyzed by the system 100. For example, the indicators and/or operational data can be organized via charts, tables, unique identifiers, graphs, directories, and/or the like.

In one or more embodiments, the correlation engine 122 can analyze the collection of indicators characterizing the given malware to determine one or more correlations between: the indicators and associated operational data; the indicators and historic malware specimens; and/or the operational data and historic malware specimens. For example, one or more correlations identified by the correlation engine can attribute observed operational data to one or more of the detected indicators. For instance, the correlation engine 122 can identify one or more correlations between the operational data and evolution indicators (e.g. code variations). In another instance, the correlation engine 122 can identify one or more correlations between the operational data and indicators extracted by the malware analyzer 118 (e.g., hidden indicators, such as metadata and/or embedded resources). In a further instance, the correlation engine 122 can correlate one or more objectives of the malware to the operational data and/or detected indicators. In a still further instance, the correlation engine 122 can correlated one or more detected signature indicators to one or more bad actors and/or historic malware campaigns. In various embodiments, the correlation engine 122 can correlate and/or aggregate the outputs from the first to the fifth phase (e.g., generated, identified, and/or detected by the delivery analyzer 116, malware analyzer 118, and/or code comparer 120) of the malware identification and/or profiling process as inputs to the profile engine 124.

In various embodiments, the correlation engine 122 can utilize one or more machine learning models 140 to determine the one or more correlations. The one or more machine learning models 140 can be computer models used to facilitate one or more machine learning tasks (e.g., regression and/or classification tasks). For example, the one or more machine learning models 140 can represent relationships (e.g., causal or correlation relationships) between parameters and/or outcomes. For instance, the one or more machine learning models 140 can represent the relationships via probabilistic determinations that can be adjusted, updated, and/or redefined based on data of the one or more data repositories 126. In various embodiments described herein, the one or more machine learning models 140 can simulate a number of interconnected processing modules that can resemble abstract versions of neurons. For example, the processing modules can be arranged in a plurality of layers (e.g., one or more input layers, hidden layers, and/or output layers) connected by varying connection strengths (e.g., which can be commonly referred to within the art as “weights”).

In one or more embodiments, the one or more machine learning models 140 can learn through training utilizing one or more of the intelligence feeds 108 as a source of training datasets; where data with known outcomes is inputted into the one or more machine learning model 140, outputs regarding the data are compared to the known outcomes, and/or the weights of the machine learning model 140 are autonomously adjusted based on the comparison to replicate the known outcomes. As the one or more machine learning models 140 train (e.g., utilize more training data), the machine learning models 140 can become increasingly accurate; thus, trained machine learning models can accurately analyze data with unknown outcomes, based on experience gained from training data and/or previous executions, to facilitate one or more machine learning tasks.

Example types of machine learning models 140 can include, but are not limited to: artificial neural network (“ANN”) models, perceptron (“P”) models, feed forward (“FF”) models, radial basis network (“RBF”) models, deep feed forward (“DFF”) models, recurrent neural network (“RNN”) models, long/short memory (“LSTM”) models, gated recurrent unit (“GRU”) models, auto encoder (“AE”) models, variational AE (“VAE”) models, denoising AE (“DAE”) models, sparse AE (“SAE”) models, markov chain (“MC”) models, Hopfield network (“HN”) models, Boltzmann machine (“BM”) models, deep belief network (“DBN”) models, convolutional neural network (“CNN”) models, deep convolutional network (“DCN”) models, deconvolutional network (“DN”) models, deep convolutional inverse graphics network (“DCIGN”) models, generative adversarial network (“GAN”) models, liquid state machine (“LSM”) models, extreme learning machine (“ELM”) models, echo state network (“ESN”) models, deep residual network (“DRN”) models, kohonen network (“KN”) models, support vector machine (“SVM”) models, and/or neural turing machine (“NTM”) models.

In one or more embodiments, the profile engine 124 can generate one or more adversary profiles that can include the one or more detected indicators, operational data, and/or data correlations. For example, the adversary profile can characterize the delivery details of the malware (e.g., based on one or more indicators detected by the delivery analyzer 116), the infrastructure of the malware (e.g., based on one or more indicators detected by the malware analyzer 118) and/or the operation of the malware (e.g., based on operational data collected by the dynamic analysis component 130). Additionally, the adversary profile can include one or more data correlations generated by the correlation engine 122. For instance, the adversary profile can include one or more predicted objective of the malware based on the detected indicators, version history, and/or operational data of the malware. In another instance, the adversary profile can attribute operational behaviors to the one or more detected indicators. In a further instance, the adversary profile can identify one or more objectives of the malware, security vulnerabilities targeted by the malware, malicious techniques employed by the malware, and/or attributing tradecrafts and/or capabilities of the malware, the malware campaign, and/or one or more bad actors associated with the malware.

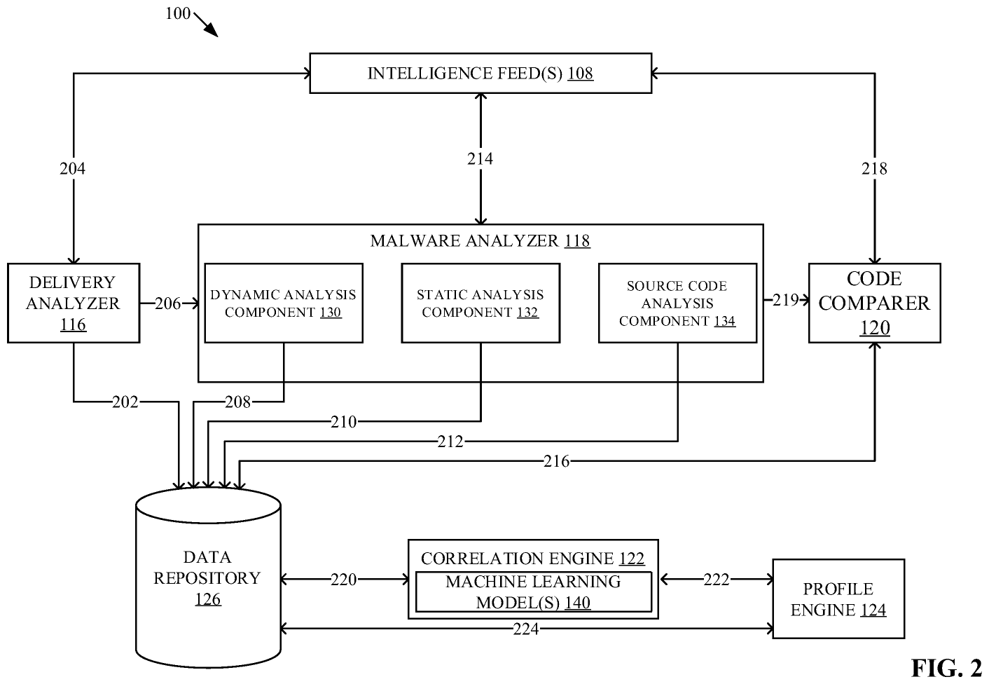

FIG. 2 illustrates a diagram of a non-limiting example data communications scheme that can be implemented by the system 100 in accordance with one or more embodiments described herein. In one or more embodiments, the computer executable instructions 112 (e.g., delivery analyzer 116, malware analyzer 118, code comparer 120, correlation engine 122, and/or profile engine 124) can be comprised within a cybersecurity device 102 (e.g., as shown in FIG. 1) and/or distributed within the network 106 (e.g., distributed within a cloud computing environment). In various embodiments, the delivery analyzer 116 can detect one or more indicators (e.g., IoCs, IoAs, and/or delivery details) relating to malware that has targeted the one or more protected computer devices 104. At 202, the delivery analyzer 116 can store the detected indicators in the one or more data repositories 126 (e.g., can populate the one or more indicators databases 129). At 204, the delivery analyzer 116 can further validate and/or authenticate the detected indicators with the one or more intelligence feeds 108. For example, the delivery analyzer 116 can search for the detected indicators amongst other cybersecurity threat analysis sources. The occurrence of the detected indicators within other malware campaigns characterized by the one or more intelligence feeds 108 can be indicative of the validity of the detected indicators in association with malware. Further, at 206 the delivery analyzer 116 can share the one or more detected indicators and/or malware delivery details with the malware analyzer 118.

In accordance with one or more embodiments, the dynamic analysis component 130 can run the malware in a sandbox environment to analyze the operational behavior of the malware. For instance, the dynamic analysis component 130 can collect additional IoCs and/or operational data from running the malware. At 208, the dynamic analysis component 130 can store the collected indicators and/or operational data in the one or more data repositories 126. Additionally, the static analysis component 132 can perform a static analysis of the malware source code to extract one or more additional hidden indicators (e.g., such as metadata, embedded strings, and/or other embedded resources). At 210, the static analysis component 132 can store the hidden indicators in the one or more data repositories 126 (e.g., in the one or more indicator databases 129). Moreover, the source code analysis component 134 can extract one or more signature indicators from the malware source code in accordance with one or more embodiments described herein. At 212, the source code analysis component 134 can store the signature indicators in the one or more data repositories 126 (e.g., in the one or more indicator databases 129). At 214, the malware analyzer 118 can utilize the one or more intelligence feeds 108 to validate and/or authenticate the various indicators detected, collected, and/or extracted by the dynamic analysis component 130, static analysis component 132, and/or source code analysis component 134.

In accordance with one or more embodiments, the code comparer 120 can compare the malware source code to one or more historic malware specimens. For example, one or more historic malware specimens can be retrieved from the one or more data repositories at 216. In another example, one or more historic malware specimens can be retrieved from the one or more intelligence feeds 108 at 218. In one or more embodiments, the malware analyzer 118 can share one or more indicators (e.g. signature indicators) with the code comparer 120 at 219 to facilitate the identification of historic malware specimens to retrieve. For instance, the one or more historic malware specimens can be previous versions of the malware. By comparing the malware source code to the one or more historic specimens, the code comparer 120 can identify one or more evolution indicators, which can be indicative of code variations exhibited by the malware. Additionally, the code comparer can store the one or more evolution indicators in the one or more data repositories 126 (e.g., in the one or more indicator databases 129) at 216. Further, the code comparer 120 can utilize the one or more intelligence feeds 108 to validate and/or authenticate one or more identified evolution indicators at 218.

In accordance with one or more embodiments described herein, the correlation engine 122 can analyze the data collected by the delivery analyzer 116, malware analyzer 118, and/or code comparer 120 to identify one or more data correlations and/or trends. For example, at 220 the correlation engine 122 can be operably coupled to the one or more data repositories 126, and/or can access the one or more indicators databases 129 and/or operations databases 136. Additionally, the profile engine 124 can generate one or more profile reports summarizing the systems' 100 malware analysis. For example, at 222 the profile engine 124 can retrieve one or more data correlations determined by the correlation engine 122. Also, at 224, the profile engine 124 can retrieve one or more indicators and/or operational data stored in the one or more data repositories 126. In one or more embodiments, the one or more profile reports can include the data correlations, indicators, and/or operational data associated with the given malware.

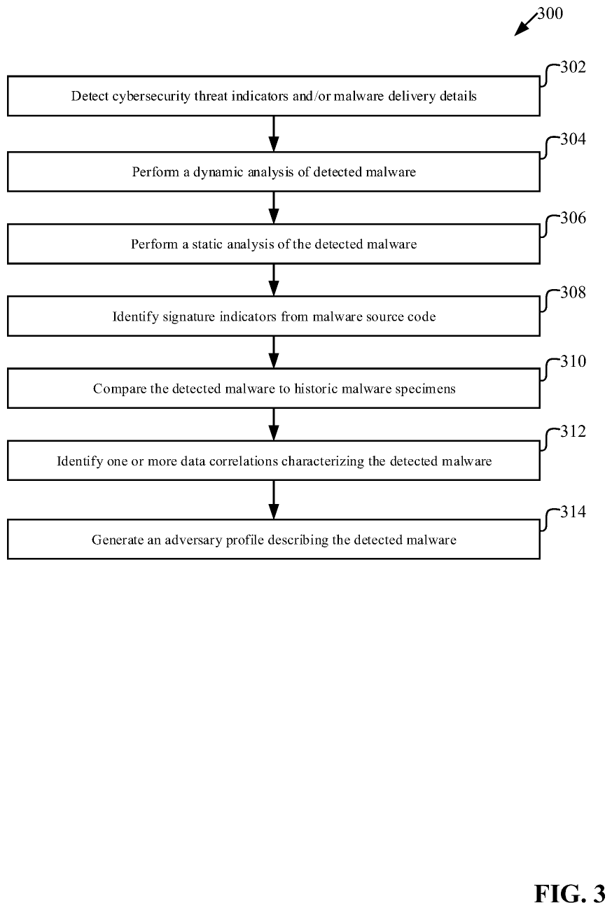

In view of the foregoing structural and functional features described above, example methods will be better appreciated with reference to FIG. 3. While, for purposes of simplicity of explanation, the example methods of FIG. 3 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 3 illustrates a non-limiting example computer-implemented method 300 that can be implemented by the system 100 to execute one or more malware identification and/or profiling processes in accordance with one or more embodiments described herein. For example, method 300 can be implemented to detect and/or analyze malware targeting one or more protected computer devices 104 and/or networks 106 of the system 100.

At 302, the method 300 can comprise identifying (e.g., via the one or more cybersecurity devices 102, operably coupled to one or more processing units 109) one or more cybersecurity threat indicators and/or malware delivery details. In accordance with various embodiments described herein, the one or more cybersecurity threat indicators (e.g., IoCs, IoAs, and/or the like) can be identified by the delivery analyzer 116 and/or security software 128 monitoring the operations of the one or more protected computer devices 104 and/or networks 106. For example, the delivery analyzer 116 can utilize one or more IoC SIEM systems, TIPs, and/or security orchestration tools to detect and/or organize IoCs and/or IoAs in the system 100. Further, where malware is delivered, and/or attempted to be delivered, via email, the delivery analyzer 116 can generate delivery data characterizing the distribution of the malware by performing one or more email header analysis and/or content examinations in accordance with one or more embodiments described herein.

Where malware is detected (e.g., as a result of the indicators and/or delivery details identified at 302), the method 300 can further perform a dynamic analysis (e.g., via the dynamic analysis component 130 and/or processing units 109) of the detected malware at 302. In accordance with one or more embodiments described herein, the dynamic analysis component 130 can run the detected malware in a sandbox environment to collect operational data and/or additional indicators regarding how the malware interacts with its host environment. At 306, the method 300 can further comprise performing a static analysis (e.g., via static analysis component 132 and/or processing units 109) of the detected malware. In accordance with one or more embodiments described herein, the static analysis component 132 can scan the malware's source code for one or more hidden indicators, such as: metadata, hashes, embedded strings, and/or the like. For example, the static analysis component 132 can execute one or more hashing algorithms. At 308, the method 300 can further comprise identifying (e.g., via the source code analysis component 134 and/or processing units 109) signature indicators from the malware source code. In accordance with one or more embodiments described herein, the signature indicators can characterize one or more digital signatures unique to the design of the malware. For instance, the signature indicators can characterize a pattern or sequence of software objects and/or artifacts found in the source code.

At 310, the method 300 can comprise comparing (e.g., via the code comparer 120 and/or processing units 109) the detected malware to historic malware specimens. In accordance with one or more embodiments described herein, the code comparer 120 can compare the detected malware to one or more historic malware specimens associated with a common indicator and/or digital signature as the detected malware. By comparing the detected malware to historic malware, the code comparer can identify code variations unique to the detected version of the malware.

At 312, the method 300 can comprise identifying (e.g., via the correlation engine 122 and/or processing units 109) one or more data correlations characterizing the detected malware. In accordance with one or more embodiments described herein, the one or more data correlations can correlate: indicators with code variations of the detected malware (e.g., as compared to historic versions of the malware); indicators with operational behavior of the malware (e.g., behavior observed from execution in the sandbox environment); indicators (e.g., identified domains) with adversarial infrastructure; indicators with adversarial capabilities; a combination thereof, and/or the like.

At 314, the method 300 can comprise generating (e.g., via the profile engine 124 and/or processing units 109) one or more profile reports describing the detected malware. In accordance with one or more embodiments described herein, the one or more profile reports can include indicators, operational data, digital signatures, and/or data correlations resulting from the method 300 and/or associated with the detect malware. In various embodiments, the security software 128 can be updated and/or reconfigured based on the one or more profile reports to thwart future cybersecurity threats. Further, the one or more profile reports can be shared with the one or more intelligence feeds 108 to improve community awareness and resistance to the malware.

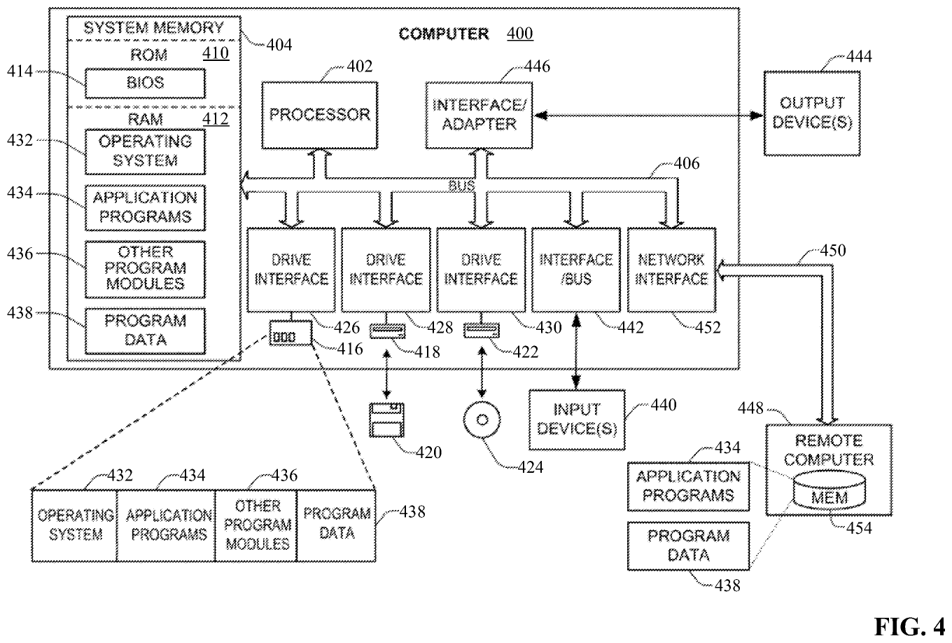

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 4 illustrates one example of a computer system 400 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418, e.g., to read from or write to removable disk 420, and an optical disk drive 422, e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 430, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 410, including operating system 432, one or more application programs 434, other program modules 436, and program data 438. In some examples, the application programs 434 can include the delivery analyzer 116, malware analyzer 118, code comparer 120, correlation engine 122, and/or profile engine 124, and the program data 438 can include various indicators (e.g., IoCs, IoAs, hidden IoCs, signature indicators, evolution indicators, and/or the like) and/or operational data of the malware. The application programs 434 and program data 438 can include functions and methods programmed to implement one or more malware identification and/or profiling processes, such as shown and described herein.

A user may enter commands and information into computer system 400 through one or more input devices 440, such as a pointing device (e.g., a mouse, touch screen), keyboard, microphone, joystick, game pad, scanner, and the like. These and other input devices 440 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and a wide area network (WAN). When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, application programs 434 or program data 438 depicted relative to computer system 400, or portions thereof, may be stored in a remote memory storage device 454.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method, comprising:
detecting one or more cybersecurity threat indicators of malware targeting a computer device, wherein the one or more cybersecurity threat indicators characterize a delivery of the malware, an infrastructure of the malware, or a combination thereof; and
generating an adversary profile that includes a correlation between the one or more cybersecurity threat indicators and an operation of the malware.

2. The method of claim 1, further comprising:
performing an email header analysis on an email associated with the malware to detect a cybersecurity threat indicator that characterizes the delivery of the malware.

3. The method of claim 2, further comprising:
performing an email content analysis that executes a natural language processing algorithm to extract a character string as a second detected cybersecurity threat indicator characterizing the delivery of the malware.

4. The method of claim 1, further comprising:
performing a dynamic analysis of the malware by executing the malware in a sandbox environment and collecting operational data that characterizes the operation of the malware; and
performing a static analysis of the malware by scanning a source code of the malware for hidden data.

5. The method of claim 4, wherein the hidden data includes metadata, embedded strings, or extracted keywords.

6. The method of claim 5, further comprising:
identifying a digital signature from the source code of the malware, wherein the digital signature is a unique identifier associated with the infrastructure of the malware; and
comparing the source code to a code snippet of a historic malware specimen, wherein the malware and the historic malware specimen both comprise the digital signature.

7. The method of claim 6, wherein the historic malware specimen is a previous version of the malware.

8. The method of claim 6, further comprising:
identifying a code variation between the source code and the code snippet, wherein the hidden data and the code variation are indicators of the one or more cybersecurity threat indicators, and wherein the correlation attributes the operation of the malware to the hidden data or the code variation.

9. A system, comprising:
memory to store computer executable instructions; and
one or more processors, operatively coupled to the memory, that execute the computer executable instructions to implement:
a malware analyzer configured to detect one or more cybersecurity threat indicators of malware targeting a computer device, wherein the one or more cybersecurity threat indicators characterize a delivery of the malware, an infrastructure of the malware, or a combination thereof; and
a profile engine configured to generate an adversary profile that includes a correlation between the one or more cybersecurity threat indicators and an operation of the malware.

10. The system of claim 9, further comprising:
a delivery analyzer configured to perform an email header analysis on an email associated with the malware to detect a cybersecurity threat indicator that characterizes the delivery of the malware.

11. The system of claim 10, wherein the delivery analyzer is further configured to perform an email content analysis that executes a natural language processing algorithm to extract a character string as a second detected cybersecurity threat indicator characterizing the delivery of the malware.

12. The system of claim 9, further comprising:
a dynamic analysis component configured to perform a dynamic analysis of the malware by executing the malware in a sandbox environment and collecting operational data that characterizes the operation of the malware; and
a static analysis component configured to perform a static analysis of the malware by scanning a source code of the malware for hidden data.

13. The system of claim 12, wherein the hidden data includes metadata, embedded strings, or extracted keywords.

14. The system of claim 12, further comprising:
a source code analysis component configured to identify a digital signature from the source code of the malware, wherein the digital signature is a unique identifier associated with the infrastructure of the malware; and
a code comparer configured to identify a code variation between the source code and a code snippet of a historic malware specimen, wherein the malware and the historic malware specimen both comprise the digital signature.

15. The system of claim 14, further comprising:
a correlation engine configured to utilize a machine learning model to generate the correlation included in the adversary profile, wherein the hidden data and the code variation are indicators of the one or more cybersecurity threat indicators, and wherein the correlation attributes the operation of the malware to the hidden data or the code variation.
